(19) United States
(12) Patent Application Publication
(10) Pub. No.: US 2023/0069571 A1
(43) Pub. Date: Mar. 2, 2023

(54) VEHICLE

(71) Applicant: HONDA MOTOR CO., LTD., Tokyo (JP)

(72) Inventor: Hiroyuki Kita, Tokyo (JP)

(21) Appl. No.: 17/892,174

(22) Filed: Aug. 22, 2022

(30) Foreign Application Priority Data
Sep. 1, 2021 (JP) 2021-142575

(51) Int. Cl. B60N 2/015; B60N 2/07; B60K 1/04

(52) U.S. Cl. CPC B60N 2/015; B60N 2/0722; B60K 1/04; B60K 2001/0433

(57) ABSTRACT

A vehicle includes a floor including a lower floor on which a high-voltage electric component is arranged and an upper floor which is arranged on an upper side of the lower floor. The vehicle includes a seat and a base. The seat is arranged above the high-voltage electric component and includes a leg portion. The base is fixed to the lower floor and is arranged on an inside in a vehicle width direction. The leg portion includes: a first leg portion that is fixed to the upper floor; and a second leg portion that is fixed to the base.

### CROSS-REFERENCE TO RELATED APPLICATION

Priority is claimed on Japanese Patent Application No. 2021-142575, filed on Sep. 1, 2021, the contents of which are incorporated herein by reference.

### BACKGROUND

### Field of the Invention

The present invention relates to a vehicle.

### Background

In recent years, from the viewpoint of adverse impacts on the global environment, for example, practical applications of technologies have been advanced which realize reduction of the environmental load such as reduction of the CO₂ emission amount by providing a high-voltage electric component (hereinafter, also referred to as a battery pack) on a vehicle and causing the vehicle to be electrically driven.

For example, as vehicles on which a battery pack is provided, such a vehicle is known in which a battery pack is provided below a seat. In such a vehicle, a battery pack is stored in an inner portion of a lower floor, and a leg portion of the seat is fixed to an upper floor above the lower floor (for example, refer to Japanese Unexamined Patent Application, First Publication No. 2004-345449).

### SUMMARY

It is conceivable that, for example, a load is input to a vehicle of Japanese Unexamined Patent Application, First Publication No. 2004-345449 from a vehicle rearward direction due to a collision (for example, a rear collision). In this case, there is a possibility that stress is concentrated on a middle portion of the upper floor or a middle portion of the lower floor due to the input load. Therefore, it is conceivable that the middle portions of the upper and lower floors (that is, the floor) are deformed due to stress concentration.

An object of an aspect of the present invention is to provide a vehicle capable of preventing stress from being concentrated on a middle portion of a floor and preventing the middle portion from being deformed when a load is input due to a vehicle collision.

A vehicle according to a first aspect of the present invention is a vehicle that includes a floor including a lower floor on which a high-voltage electric component is arranged and an upper floor which is arranged on an upper side of the lower floor, the vehicle including: a seat that is arranged above the high-voltage electric component and includes a leg portion; and a base that is fixed to the lower floor and is arranged on an inside in a vehicle width direction, wherein the leg portion includes: a first leg portion that is arranged on an outside in the vehicle width direction of the base and is fixed to the upper floor; and a second leg portion that is arranged on an inside in the vehicle width direction of the first leg portion and is fixed to the base.

According to this configuration, the base is arranged on the inside in the vehicle width direction and is fixed to the lower floor. Therefore, when the vehicle collides (for example, a rear collision), a load that is input from a vehicle rearward direction is dispersed to the base, and thereby, it is possible to prevent stress from concentrating on a middle portion of the lower floor. Thereby, it is possible to prevent the stress from being concentrated on the middle portion of the lower floor due to the load that is input at the time of a collision by the base. Accordingly, it is possible to prevent the lower floor (the floor) from being deformed from the middle portion by the base. Hereinafter, the embodiment is described using a “rear collision” as a representative example of a collision.

Further, the second leg portion among the leg portions is arranged on the inside in the vehicle width direction of the first leg portion and is fixed (connected) to the base. Therefore, the base can be reinforced by the second leg portion, and a load that is input due to a rear collision of the vehicle can be further favorably dispersed from the base to the second leg portion. Thereby, it is possible to further favorably prevent the stress from being concentrated on the middle portion of the lower floor due to the load that is input at the time of the rear collision by the second leg portion. Accordingly, it is possible to further favorably prevent the lower floor (that is, the floor) from being deformed from the middle portion by the second leg portion.

In a second aspect, the base may be fixed to a cross member that is arranged along the lower floor.

According to this configuration, the base is fixed to the cross member via the lower floor. The cross member is a member that improves the rigidity and the strength of a vehicle body. Specifically, the cross member is, for example, a member that extends in the vehicle width direction, is provided on the frames that constitute part of a vehicle body skeleton, and has a high rigidity and a high strength.

Therefore, by fixing (connecting) the base to the cross member via the lower floor, the base and the lower floor can be reinforced by the cross member. Thereby, for example, a load that is input due to a rear collision of the vehicle can be further favorably dispersed from the base to the cross member.

Therefore, it is possible to further favorably prevent the stress from being concentrated on the middle portion of the lower floor due to the load that is input at the time of the rear collision by the cross member. Thereby, it is possible to further favorably prevent the lower floor (that is, the floor) from being deformed from the middle portion by the cross member.

In a third aspect, the second leg portion may include: a front end section at a vehicle forward side that is fixed to the upper floor; and a rear end section at a vehicle rearward side that is fixed to the base.

According to this configuration, the front end section of the second leg portion is fixed to the upper floor, and the rear end section is fixed to the base. Therefore, for example, a load that is input due to a rear collision of the vehicle can be further favorably dispersed from the second leg portion to the upper floor. That is, for example, when the load is input from the vehicle rearward direction due to the rear collision of the vehicle, the second leg portion can hold on by the upper floor. Thereby, it is possible to further favorably prevent the lower floor (the floor) from being deformed from the middle portion by the load that is input at the time of the rear collision.

In a fourth aspect, the seat may include a seat main body that is supported by the leg portion, the leg portion may be constituted of a pair of slide rails in which the first leg portion and the second leg portion support the seat main body slidably in a vehicle forward-rearward direction, and the slide rail of the second leg portion may be fixed to the base.

According to this configuration, the first leg portion and the second leg portion are constituted of the pair of slide rails, and a rear end section of the slide rail of the second leg portion is fixed to the base. The slide rail is a long member that extends in the vehicle forward-rearward direction. Therefore, the contact area between the slide rail and the base can be increased. Thereby, the base can be further favorably reinforced by the slide rail of the second leg portion. Accordingly, a load that is input due to a rear collision of the vehicle can be further favorably dispersed from the base to the second leg portion, and it is possible to further favorably prevent the lower floor (the floor) from being deformed from the middle portion.

In a fifth aspect, the seat may include a first seat and a second seat that are individually provided in the vehicle width direction, and the second leg portion of each of the first seat and the second seat may be fixed to the base.

According to this configuration, the seat is constituted of the first seat and the second seat, and the second leg portion of each of the first seat and the second seat is fixed to the base. Therefore, two second leg portions that are provided on the first seat and the second seat can be fixed (connected) to the base. Thereby, the base can be further favorably reinforced by the two second leg portions. Accordingly, a load that is input due to a rear collision of the vehicle can be further favorably dispersed from the base to the two second leg portions, and it is possible to further favorably prevent the lower floor (the floor) from being deformed from the middle portion.

According to an aspect of the present invention, it is possible to prevent stress from being concentrated on the middle portion of the floor and prevent the middle portion from being deformed when a load is input due to a vehicle collision (for example, a rear collision).

### BRIEF DESCRIPTION OF THE DRAWINGS

FIG. 1 is a schematic perspective view illustrating a vehicle of an embodiment according to the present invention.

FIG. 2 is a plan view illustrating the vehicle of the embodiment.

FIG. 3 is an exploded perspective view illustrating the vehicle of the embodiment.

FIG. 4 is a perspective view of the vehicle of the embodiment when seen from a rearward leftward direction.

FIG. 5 is a perspective view in which the vehicle of the embodiment is broken in a cross-section in a vehicle width direction at a first cross member.

FIG. 6 is a cross-sectional view in which the vehicle of the embodiment is broken in a vehicle body forward-rearward direction at an inlet portion of a battery pack.

FIG. 7 is a perspective view illustrating a base and a first cross member that are provided on the vehicle of the embodiment.

FIG. 8 is a plan view in which part of the battery pack provided on the vehicle of the embodiment is broken in a cross-section except for a top portion of a pack housing.

FIG. 9 is a plan view in which the battery pack provided on the vehicle of the embodiment is disassembled.

### DESCRIPTION OF EMBODIMENTS

Hereinafter, a vehicle according to an embodiment of the present invention will be described with reference to the drawings. In the drawings, an arrow FR indicates a forward direction of the vehicle, an arrow UP indicates an upward direction of the vehicle, and an arrow LH indicates a leftward direction of the vehicle.

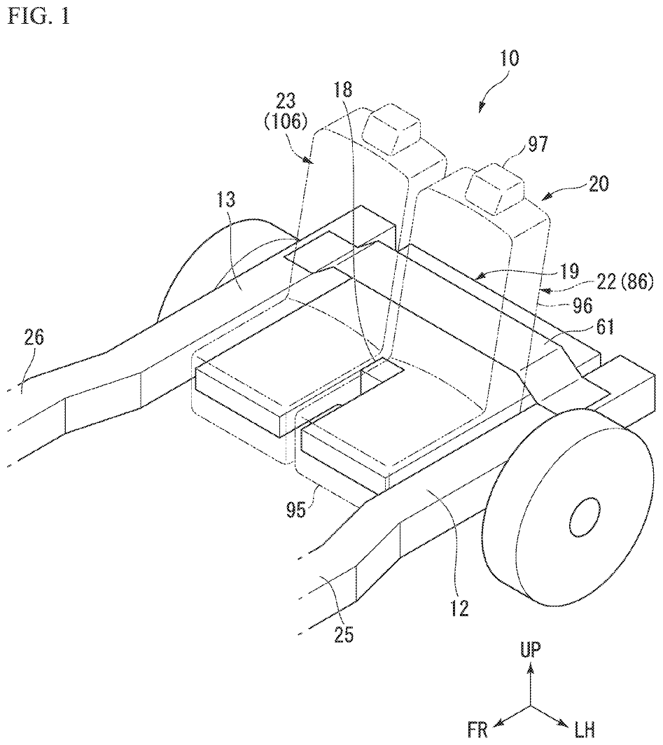

As shown in FIG. 1 to FIG. 3, a vehicle 10 includes a left rear frame 12, a right rear frame 13, a floor panel (floor) 14, a first cross member (cross member) 15, a second cross member 16, a base 18, a high-voltage electric component 19, and a seat 20.

That is, the vehicle 10 is a vehicle with a high-voltage electric component that includes the high-voltage electric component 19. Hereinafter, the high-voltage electric component 19 may be referred to as a “battery pack 19”.

The left rear frame 12 is provided on a lower section of a vehicle body rear portion at a left outer side in a vehicle width direction and extends in a vehicle rearward direction from a rear end portion of a left side sill 25. The right rear frame 13 is provided on the lower section of the vehicle body rear portion at a right outer side in the vehicle width direction and extends in the vehicle rearward direction from a rear end portion of a right side sill 26.

The left rear frame 12 and the right rear frame 13 are, for example, skeleton members having a high rigidity and that constitute part of a vehicle body skeleton by being formed in a hollow closed cross-section. The left side sill 25 and the right side sill 26 are, for example, skeleton members having a high rigidity and that constitute part of a vehicle body skeleton by being formed in a hollow closed cross-section.

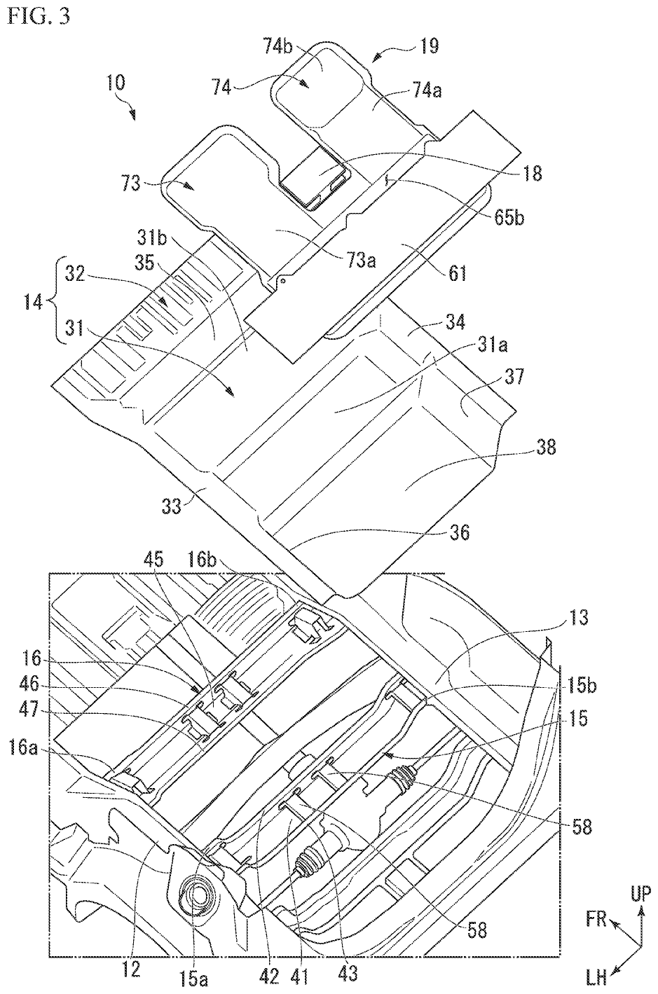

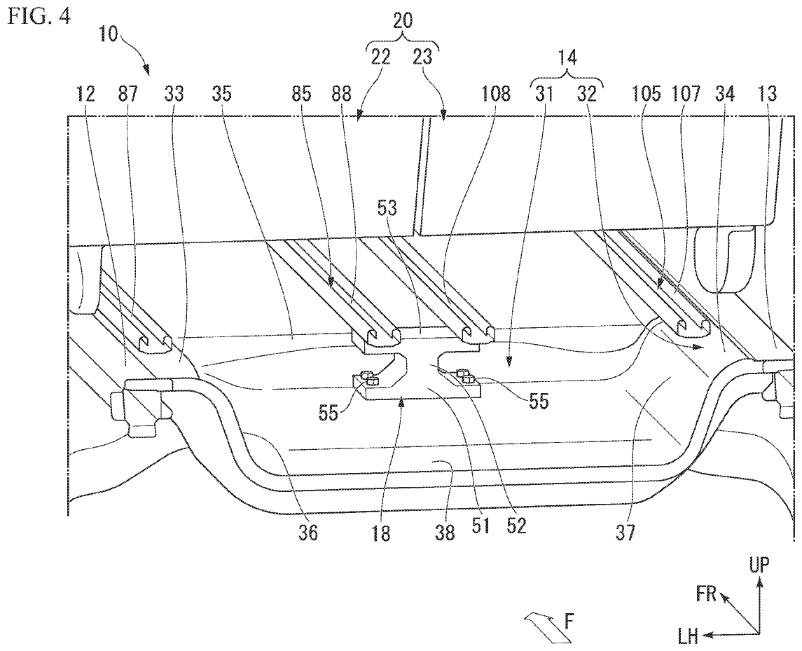

As shown in FIG. 3 and FIG. 4, the floor panel 14 is provided between the left rear frame 12 and the right rear frame 13. The floor panel 14 includes a lower floor 31 and an upper floor 32.

The upper floor 32 is arranged above the lower floor 31. The upper floor 32 includes a left upper floor portion 33, a right upper floor portion 34, and a front upper floor portion 35. The left upper floor portion 33 is joined to an upper surface of the left rear frame 12. The right upper floor portion 34 is joined to an upper surface of the right rear frame 13. The front upper floor portion 35 forms part of a floor surface of a vehicle room (a vehicle room space) and supports a vehicle forward-side section of a left leg portion 85 and a right leg portion 105 described later.

The battery pack 19 described later is arranged on the lower floor 31 from an upward direction. The lower floor 31 includes a left floor side-surface portion 36, a right floor side-surface portion 37, and a floor bottom-surface portion 38.

The left floor side-surface portion 36 extends downward from an inner side of the left upper floor portion 33. The right floor side-surface portion 37 extends downward from an inner side of the right upper floor portion 34. The floor bottom-surface portion 38 is connected to a lower side of the left floor side-surface portion 36 and a lower side of the right floor side-surface portion 37 and is arranged horizontally in the vehicle width direction.

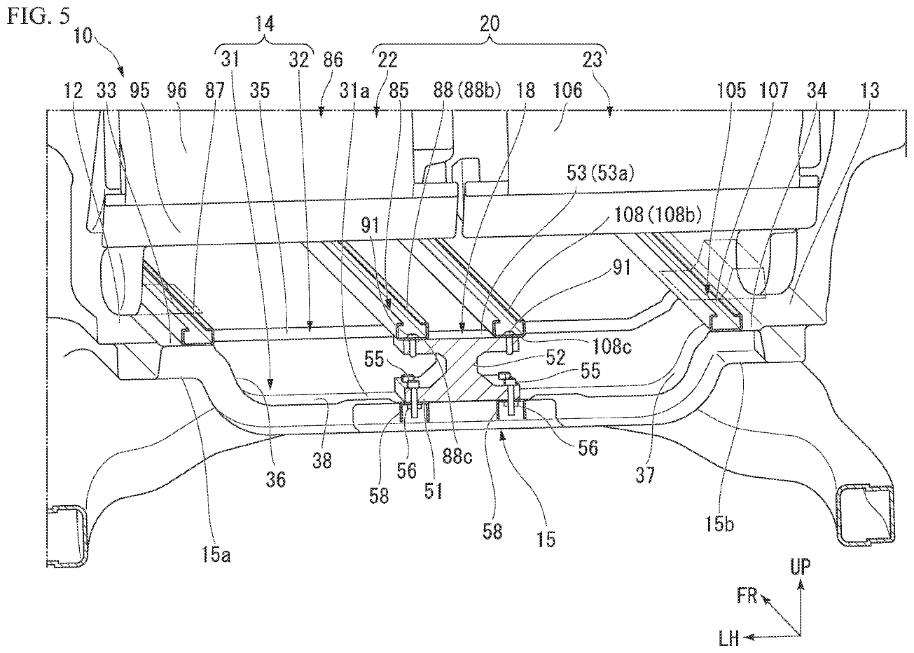

That is, the lower floor 31 is formed of the left floor side-surface portion 36, the right floor side-surface portion 37, and the floor bottom-surface portion 38 in a U shape (bow shape) in a rear view when seen from a vehicle rearward direction (also refer to FIG. 5).

The lower floor 31 is formed in a U shape, and the floor bottom-surface portion 38 is formed so as to be gradually lowered in a step manner from the front upper floor portion 35 toward the vehicle rearward direction. Therefore, the floor bottom-surface portion 38 can be lowered downward. Thereby, a storage space capable of storing the battery pack 19 described later and the base 18 described later from an upward direction can be ensured in an inner portion of the lower floor 31.

Further, by forming the lower floor 31 in a U shape, the strength and the rigidity of the lower floor 31 itself are ensured.

As shown in FIG. 3 and FIG. 5, the first cross member 15 extends, for example, in a vehicle width direction along a lower surface of a middle portion 31a in a vehicle forward-rearward direction of the lower floor 31. The first cross member 15 has a left end portion 15a that is joined to the left rear frame 12 and a right end portion 15b that is joined to the right rear frame 13. That is, the first cross member 15 is provided on and between the left rear frame 12 and the right rear frame 13.

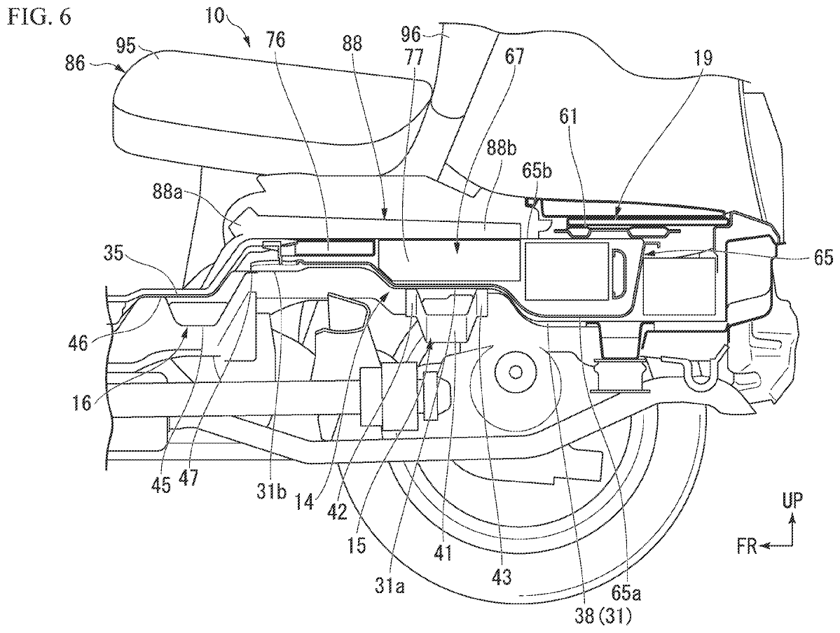

As shown in FIG. 3 and FIG. 6, the first cross member 15 is formed of a first U-shaped cross-sectional portion 41, a first front flange 42, and a first rear flange 43 in a hat shape in a cross-section. The first front flange 42 and the first rear flange 43 of the first cross member 15 are joined to a lower surface of the lower floor 31 at the central portion 31a.

Therefore, the first cross member 15 is a member having a high strength and a high rigidity formed in a closed cross-section together with the lower floor 31. That is, the rigidity and the strength of the vehicle body are improved by the first cross member 15.

The second cross member 16 extends in the vehicle width direction, for example, in a state of being provided on and between a lower surface of the front upper floor portion 35 and a lower surface of a front end portion 31b of the lower floor 31 in the vehicle forward-rearward direction. The second cross member 16 has a left end portion 16a that is joined to a lower end portion of the left rear frame 12 and a right end portion 16b that is joined to a lower end portion of the right rear frame 13. That is, the second cross member 16 is provided on and between the left rear frame 12 and the right rear frame 13.

The second cross member 16 is formed of a second U-shaped cross-sectional portion 45, a second front flange 46, and a second rear flange 47 in a hat shape in a cross-section. In the second cross member 16, for example, the second front flange 46 is joined to a lower surface of the front upper floor portion 35, and the second rear flange 47 is joined to a lower surface of the lower floor 31 at the front end portion 31b. Therefore, the second cross member 16 is a member having a high strength and a high rigidity formed in a closed cross-section together with the front upper floor portion 35 and the front end portion 31b of the lower floor 31. That is, the rigidity and the strength of the vehicle body are improved by the second cross member 16.

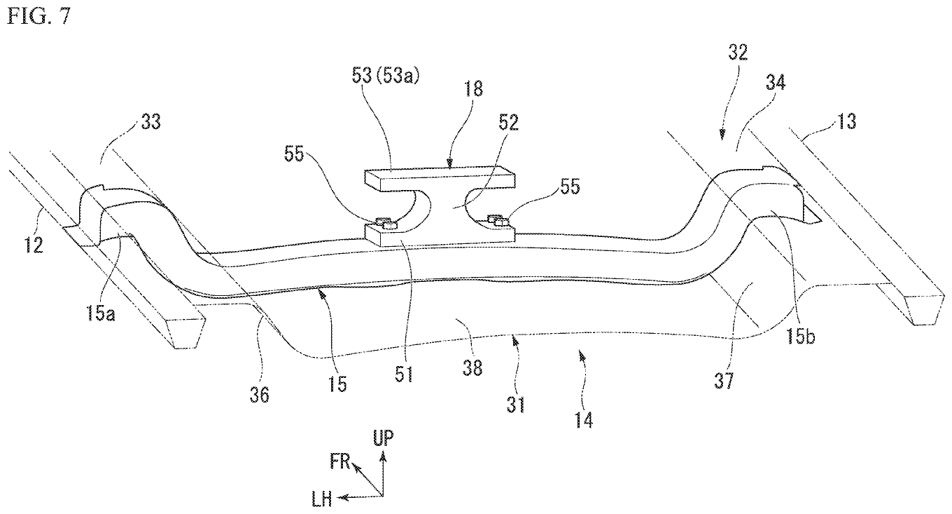

As shown in FIG. 5 and FIG. 7, the base 18 is provided on the inner portion of the lower floor 31. The base 18 is arranged on a middle in the vehicle width direction in the inner portion of the lower floor 31. The base 18 includes, for example, a lower extension portion 51, a longitudinal connection portion 52, and an upper extension portion 53. The base 18 is formed of, for example, the lower extension portion 51, the longitudinal connection portion 52, and the upper extension portion 53 in an I shape in a cross-section.

The lower extension portion 51 is arranged, for example, on a surface (an inner surface) of the floor bottom-surface portion 38 at a middle position in the vehicle width direction and is formed in a rectangular shape in plan view by extending in the vehicle width direction. The longitudinal connection portion 52 protrudes upward, for example, from a middle section in the vehicle width direction of the lower extension portion 51. The upper extension portion 53 extends, for example, from an upper end section of the longitudinal connection portion 52 to left and right sides in the vehicle width direction.

In other words, a middle section in the vehicle width direction of the upper extension portion 53 is connected to the upper end section of the longitudinal connection portion 52. The upper extension portion 53 has, for example, an upper surface section 53a that is formed to be flat. The upper surface section 53a of the upper extension portion 53 is formed at approximately the same height as the left upper floor portion 33 and the right upper floor portion 34 of the upper floor 32 in an upward-downward direction.

The lower extension portion 51 is arranged on a surface of the floor bottom-surface portion 38, and the base 18 is fixed to the first cross member 15 via the floor bottom-surface portion 38 by a fastening member (for example, a bolt 55 and a nut 56). Specifically, in the base 18, for example, both end sections in the vehicle width direction of the lower extension portion 51 are fixed to the middle portion in the vehicle width direction of the first cross member 15 and the floor bottom-surface portion 38 via a pair of brackets 58 (refer to FIG. 3) by the bolt 55 and the nut 56.

That is, the lower extension portion 51 is fixed to the floor bottom-surface portion 38 and the first cross member 15.

In this way, the base 18 is arranged at the middle in the vehicle width direction and is fixed to the floor bottom-surface portion 38 (that is, the lower floor 31). Therefore, for example, when the vehicle 10 is subject to a rear collision, a load F (refer to FIG. 4) that is input from a vehicle rearward direction can be dispersed to the base 18. The embodiment is described using a “rear collision” as a representative example of a collision; however, a collision is not limited to the rear collision. For example, the present invention may be applied to another collision such as a front collision.

The base 18 is fixed to the first cross member 15. The first cross member 15 is a member having a high rigidity and a high strength. Therefore, by fixing (connecting) the base 18 to the floor bottom-surface portion 38 (the lower floor 31) and the first cross member 15, the base 18 and the lower floor 31 can be reinforced by the first cross member 15. Thereby, for example, the load F that is input due to a rear collision of the vehicle can be further favorably dispersed from the base 18 to the first cross member 15.

The embodiment is described using an example in which the base 18 is provided at the middle position in the vehicle width direction; however, the embodiment is not limited thereto. Similar effects can be also obtained by providing the base 18 at an arbitrary inner position in the vehicle width direction.

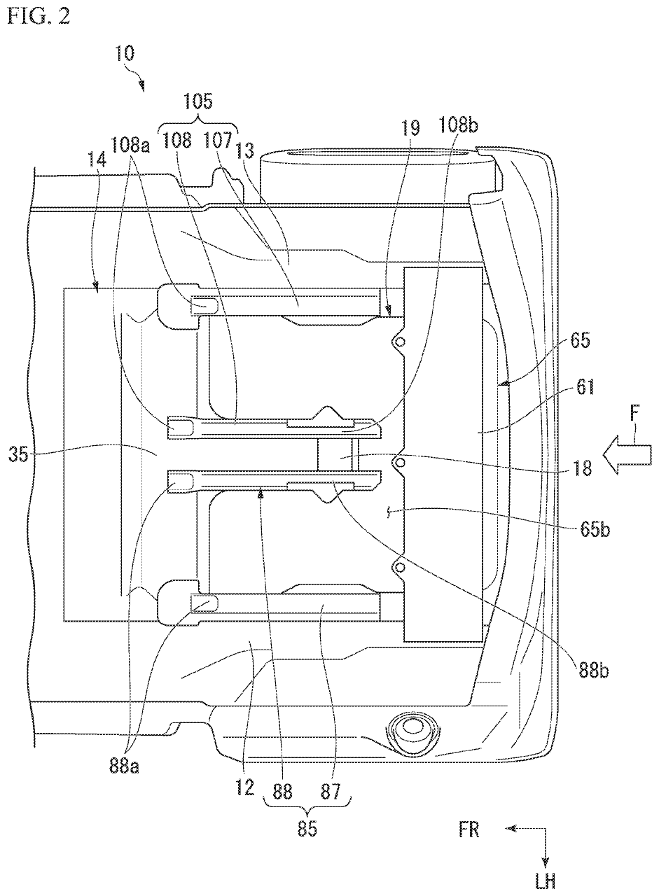

As shown in FIG. 2, FIG. 3, and FIG. 6, the battery pack 19 is stored in the inner portion of the lower floor 31 on which the base 18 is arranged. The battery pack 19 is supported by the left rear frame 12 and the right rear frame 13 via a pack support frame 61. Specifically, the pack support frame 61 extends in the vehicle width direction by being provided on and between an upper surface of the left rear frame 12 and an upper surface of the right rear frame 13. The battery pack 19 is attached to the pack support frame 61.

Thereby, the battery pack 19 is supported by the upper surface of the left rear frame 12 and the upper surface of the right rear frame 13 via the pack support frame 61 and is provided (arranged) above the floor bottom-surface portion 38.

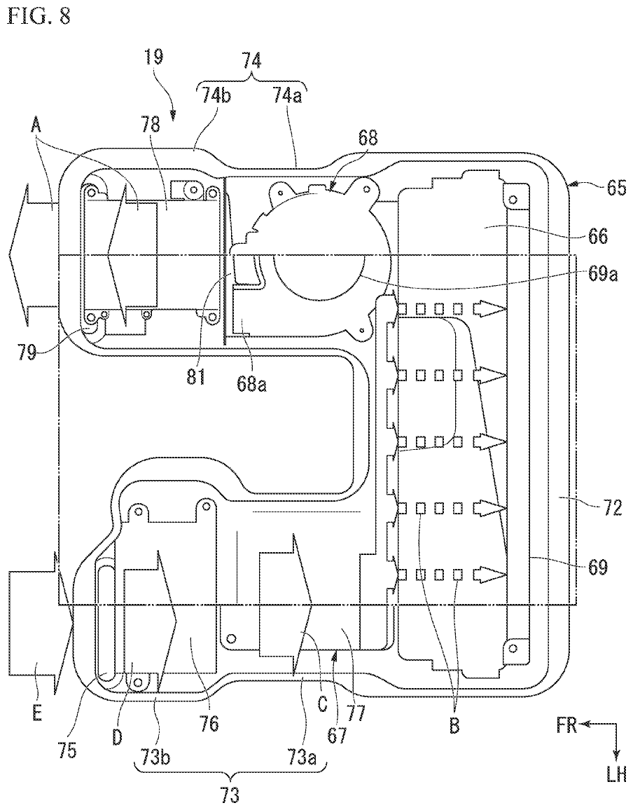

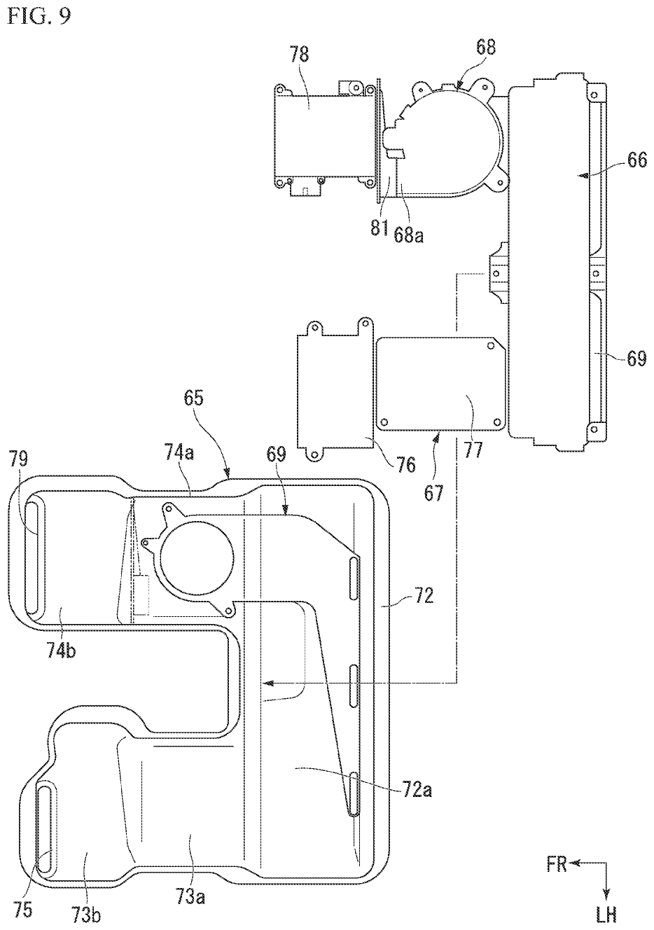

As shown in FIG. 8 and FIG. 9, the battery pack 19 includes a pack housing 65, a battery module 66, an electric component 67, a cooling fan 68, and a cooling duct 69. The pack housing 65 is formed of a battery storage portion 72, an inlet portion 73, and an outlet portion 74 in a U shape in plan view.

The inlet portion 73 includes a first inlet section 73a and a second inlet section 73b. A first opening portion 75 opens at the second inlet section 73b. The second inlet section 73b is in communication with a vehicle room space through the first opening portion 75. The outlet portion 74 includes a first outlet section 74a and a second outlet section 74b. A second opening portion 79 opens at the second outlet section 74b. The second outlet section 74b is in communication with the vehicle room space through the second opening portion 79.

The base 18 (refer to FIG. 3) is arranged on the battery pack 19 formed in a U shape between the first inlet section 73a and the first outlet section 74a.

As shown in FIG. 6, the pack housing 65 is formed, for example, such that a bottom portion 65a is gradually lowered in a step manner toward the vehicle rearward direction along the floor bottom-surface portion 38. The pack housing 65 has, for example, a top portion 65b formed to be flat and is arranged at a position that is substantially at the same height as the left upper floor portion 33 and the right upper floor portion 34 (refer to FIG. 3) of the upper floor 32 in an upward-downward direction.

With reference back to FIG. 8 and FIG. 9, the battery module 66, the electric component 67, the cooling fan 68, and the cooling duct 69 are stored in the pack housing 65.

The battery module 66 is, for example, a battery module for driving. The battery module 66 extends in the vehicle width direction in a state of being stored in the battery storage portion 72 at a vehicle rearward position of the pack housing 65. The battery module 66 is formed, for example, in a rectangular body in which a plurality of batteries are overlapped with each other in the vehicle width direction and is stored in the battery storage portion 72 so as to face in the vehicle width direction.

Examples of the electric component 67 include a battery ECU 76, a high-voltage junction board 77, and a DC/DC converter 78. Hereinafter, the battery ECU 76 may be referred to as an ECU 76. Hereinafter, the high-voltage junction board 77 may be referred to as a J/B 77.

The ECU 76 is arranged, for example, inside the second inlet section 73b. The ECU 76 is, for example, a battery management unit that controls discharging and charging between the battery module 66 for driving and a motor for driving (not shown).

The J/B 77 is arranged, for example, inside the first inlet section 73a. The J/B 77 is, for example, a device that supplies the electricity of the battery module 66 for driving stored in the battery storage portion 72 to the motor for driving.

The DC/DC converter 78 is arranged, for example, inside the second outlet section 74b. The DC/DC converter 78 is a device that converts a voltage into a voltage which can operate each electronic device (specifically, the ECU 76 and the J/B 77) provided in the inlet portion 73 of the pack housing 65 and stabilizes the converted voltage.

The cooling fan 68 is arranged, for example, inside the first outlet section 74a. The battery module 66, the ECU 76, the J/B 77, and the DC/DC converter 78 are cooled by the operation of the cooling fan 68. Specifically, the cooling fan 68 includes an intake port that is provided on a lower portion of the cooling fan 68 and an exhaust port 68a that opens to the inside of the second outlet section 74b. The intake port opens to the cooling duct 69 (described later) of the first outlet section 74a.

A partition wall 81 is provided at the boundary between the first outlet section 74a and the second outlet section 74b.

The partition wall 81 separates the first outlet section 74a and the second outlet section 74b at the boundary, and a portion of the partition wall 81 that faces the exhaust port 68a opens. Therefore, the exhaust port 68a opens to the second outlet section 74b and is in communication with the second opening portion 79 through the second outlet section 74b.

The cooling duct 69 is provided, for example, on the battery storage portion 72. The cooling duct 69 is arranged, for example, on a lower surface section 72a and at a rear end portion of the battery module 66 in the inside of the battery storage portion 72.

The cooling duct 69 has, for example, a suction port that opens at the rear of the battery module 66. Further, the cooling duct 69 is arranged below the cooling fan 68. The cooling duct 69 has a discharge port 69a that opens toward the intake port of the cooling fan 68.

According to the battery pack 19, by driving the cooling fan 68, air in the cooling duct 69 is suctioned from the intake port through the discharge port 69a of the cooling duct 69. The cooling fan 68 discharges the suctioned air from the exhaust port 68a to the second outlet section 74b. The air discharged to the second outlet section 74b is reliably discharged from the second opening portion 79 to the vehicle room space as indicated by an arrow A.

On the other hand, the air in the cooling duct 69 is suctioned by the cooling fan 68, and thereby, the air in the battery storage portion 72 is suctioned through the suction port of the cooling duct 69 into the cooling duct 69 as indicated by an arrow B. The air in the battery storage portion 72 is suctioned into the cooling duct 69, and thereby, the air in the first inlet section 73a is guided into the battery storage portion 72 as indicated by an arrow C.

The air in the first inlet section 73a is guided into the battery storage portion 72, and thereby, the air in the second inlet section 73b is guided into the first inlet section 73a as indicated by an arrow D. The air in the second inlet section 73b is guided into the first inlet section 73a, and thereby, the air in the vehicle room space is guided into the second inlet section 73b through the first opening portion 75 as indicated by an arrow E.

Thereby, the ECU 76 and the JIB 77 stored within the inlet portion 73 can be cooled by the air suctioned from the vehicle room space. Further, the battery module 66 stored within the battery storage portion 72 (the cooling duct 69) can be cooled by the air guided from the inlet portion 73. Further, the DC/DC converter 78 stored within the outlet portion 74 can be cooled by the air guided from the battery storage portion 72 (the cooling duct 69).

As shown in FIG. 1 and FIG. 4, the seat 20 is arranged above the battery pack 19.

The seat 20 includes a left rear seat (first seat) 22 and a right rear seat (second seat) 23. The left rear seat 22 and the right rear seat 23 are individually provided in the vehicle width direction.

Specifically, the left rear seat 22 is provided in a left half region in the vehicle width direction above the battery pack 19. The right rear seat 23 is provided in a right half region in the vehicle width direction above the battery pack 19.

In the embodiment, the left rear seat 22 is described as an example of a first seat, and the right rear seat 23 is described as an example of a second seat; however, the first seat and the second seat are not limited to the left rear seat 22 and the right rear seat 23.

As shown in FIG. 2, FIG. 5, and FIG. 6, the left rear seat 22 includes a left leg portion (leg portion) 85 and a left seat main body (seat main body) 86. The left leg portion 85 includes a first left leg portion (first leg portion) 87 and a second left leg portion (second leg portion) 88.

The first left leg portion 87 is arranged on a left outside (that is, an outside in the vehicle width direction) of the base 18 in the vehicle width direction and is fixed to the left upper floor portion 33 from the upward direction. Therefore, the first left leg portion 87 is joined to the left rear frame 12 via the left upper floor portion 33. The first left leg portion 87 is constituted of a slide rail and extends in a vehicle body forward-rearward direction.

The second left leg portion 88 is arranged on an inside (that is, a middle side in the vehicle width direction) of the first left leg portion 87 in the vehicle width direction. Similarly to the first left leg portion 87, the second left leg portion 88 is constituted of a slide rail and extends in the vehicle body forward-rearward direction.

The second left leg portion 88 includes a front end leg section (a front end section) 88a and a rear end leg section (a rear end section) 88b. The front end leg section 88a constitutes a portion on a vehicle forward side of the second left leg portion 88 that extends in the vehicle body forward-rearward direction. The front end leg section 88a is fixed to the front upper floor portion 35 of the upper floor 32, for example, by a jointing or a fastening member.

The rear end leg section 88b constitutes a portion on a vehicle rearward side of the second left leg portion 88 that extends in the vehicle body forward-rearward direction. The rear end leg section 88b is fixed to a left end section of the upper extension portion 53 of the base 18 by a fastening member (for example, a bolt 91). That is, the second left leg portion 88 is fixed to the base 18.

Therefore, the base 18 is reinforced by the second left leg portion 88. Thereby, for example, a load F that is input due to a rear collision of the vehicle 10 can be further favorably dispersed from the base 18 to the second left leg portion 88.

Further, in the second left leg portion 88, the front end leg section 88a is fixed to the front upper floor portion 35, and the rear end leg section 88b is fixed to the base 18. Therefore, for example, a load F that is input due to a rear collision of the vehicle 10 can be further favorably dispersed from the second left leg portion 88 to the front upper floor portion 35. That is, when the load F is input from the vehicle rearward direction due to the rear collision of the vehicle 10, the second left leg portion 88 can hold on by the front upper floor portion 35 (that is, the upper floor 32).

In particular, the second left leg portion 88 is constituted of the slide rail. The slide rail is a long member that extends in the vehicle forward-rearward direction, and a lower end surface portion is formed to be flat. Therefore, a lower end surface portion 88c of the rear end leg section 88b is formed to be flat. Further, the upper surface section 53a of the upper extension portion 53 is also formed to be flat. Therefore, the lower end surface portion 88c of the rear end leg section 88b is fixed in a state of being in surface contact with the upper surface section 53a of the upper extension portion 53, and it is possible to increase a contact area with the upper surface section 53a of the upper extension portion 53.

Thereby, the base 18 can be further favorably reinforced by the slide rail of the second left leg portion 88. Accordingly, for example, a load F that is input due to a rear collision of the vehicle 10 can be further favorably dispersed from the base 18 to the second left leg portion 88.

Further, the first left leg portion 87 and the second left leg portion 88 are arranged to be spaced in the vehicle width direction from each other and constituted of a pair of slide rails that extend in the vehicle forward-rearward direction. The left seat main body 86 is supported slidably in the vehicle forward-rearward direction by the first left leg portion 87 and the second left leg portion 88. The left seat main body 86 includes a seat cushion 95, a seat back 96, and a head rest 97 (refer to FIG. 1).

That is, the first left leg portion 87 and the second left leg portion 88 (specifically, the pair of first slide rails) are members having a high strength and a high rigidity that support the left seat main body 86 to be movable in the vehicle forward-rearward direction.

As shown in FIG. 2 and FIG. 5, the right rear seat 23 includes a right leg portion (leg portion) 105 and a right seat main body (seat main body) 106. The right leg portion 105 includes a first right leg portion (first leg portion) 107 and a second right leg portion (second leg portion) 108.

The right rear seat 23 is formed such that components of the first right leg portion 107, the second right leg portion 108, and the right seat main body 106 are approximately symmetrical in a leftward-rightward direction with respect to the components (that is, the first left leg portion 87, the second left leg portion 88, and the left seat main body 86) of the left rear seat 22. Therefore, detailed descriptions of the first right leg portion 107, the second right leg portion 108, and the right seat main body 106 are omitted.

Here, the first right leg portion 107 is arranged on a right outside (that is, an outside in the vehicle width direction) of the base 18 in the vehicle width direction and is fixed to the right upper floor portion 34 from the upward direction. Therefore, the first right leg portion 107 is joined to the right rear frame 13 via the right upper floor portion 34. The first right leg portion 107 is constituted of a slide rail and extends in the vehicle body forward-rearward direction.

Further, the second right leg portion 108 includes a front end leg section (a front end section) 108a and a rear end leg section (a rear end section) 108b. The front end leg section 108a constitutes a portion on a vehicle forward side of the second right leg portion 108 that extends in the vehicle body forward-rearward direction. The front end leg section 108a is fixed to the front upper floor portion 35 of the upper floor 32, for example, by a jointing or a fastening member.

The rear end leg section 108b constitutes a portion on a vehicle rearward side of the second right leg portion 108 that extends in the vehicle body forward-rearward direction. The rear end leg section 108b is fixed to a right end section of the upper extension portion 53 of the base 18 by a fastening member (for example, a bolt 91). That is, the second left leg portion 108 is fixed to the base 18.

Therefore, the base 18 can be reinforced by the second right leg portion 108, and, for example, a load F that is input due to a rear collision of the vehicle 10 can be further favorably dispersed from the base 18 to the second right leg portion 108.

Further, in the second right leg portion 108, the front end leg section 108a is fixed to the front upper floor portion 35, and the rear end leg section 108b is fixed to the base 18. Therefore, for example, a load F that is input due to a rear collision of the vehicle 10 can be further favorably dispersed from the second right leg portion 108 to the front upper floor portion 35. That is, when the load F is input from the vehicle rearward direction due to the rear collision of the vehicle 10, the second right leg portion 108 can hold on by the front upper floor portion 35 (that is, the upper floor 32).

In particular, the second right leg portion 108 is constituted of the slide rail. The slide rail is a long member that extends in the vehicle forward-rearward direction, and a lower end surface portion is formed to be flat. Therefore, a lower end surface portion 108c of the rear end leg section 108b is formed to be flat. Further, the upper surface section 53a of the upper extension portion 53 is also formed to be flat. Therefore, the lower end surface portion 108c of the rear end leg section 108b is fixed in a state of being in surface contact with the upper surface section 53a of the upper extension portion 53, and it is possible to increase a contact area with the upper surface section 53a of the upper extension portion 53.

Thereby, the base 18 can be further favorably reinforced by the slide rail of the second right leg portion 108. Accordingly, for example, a load F that is input due to a rear collision of the vehicle 10 can be further favorably dispersed from the base 18 to the second right leg portion 108.

Here, the seat 20 includes two seats which are the left rear seat 22 and the right rear seat 23. The second left leg portion 88 of the left rear seat 22 is fixed to the base 18. The second right leg portion 108 of the right rear seat 23 is fixed to the base 18. Therefore, two second leg portions which are the second left leg portion 88 of the left rear seat 22 and the second right leg portion 108 of the right rear seat 23 can be fixed (connected) to the base 18.

Thereby, the base 18 can be further favorably reinforced by the two second leg portions, which are the second left leg portion 88 and the second right leg portion 108. Accordingly, for example, a load F that is input due to a rear collision of the vehicle 10 can be further favorably dispersed from the base 18 to the two second leg portions, which are the second left leg portion 88 and the second right leg portion 108.

As described above, according to the vehicle 10 of the embodiment, the following actions and effects can be obtained.

That is, as shown in FIG. 2 and FIG. 5, the base 18 is arranged at the middle in the vehicle width direction and is fixed to the floor bottom-surface portion 38 (the lower floor 31), and thereby, for example, a load F that is input from a vehicle rearward direction due to a rear collision can be dispersed to the base 18. Therefore, it is possible to prevent stress from concentrating on the middle portion 31a of the lower floor 31.

Thereby, for example, it is possible to prevent the stress from being concentrated on the middle portion 31a of the lower floor 31 due to the load F that is input at the time of the rear collision by the base 18. Accordingly, it is possible to prevent the lower floor 31 (that is, the floor panel 14) from being deformed from the middle portion 31a by the base 18.

Thereby, the battery pack 19 can be protected from the load F that is input due to the rear collision.

Here, the seat 20 includes two seats which are the left rear seat 22 and the right rear seat 23. The second left leg portion 88 of the left rear seat 22 is fixed to the base 18. The second right leg portion 108 of the right rear seat 23 is fixed to the base 18. Therefore, two second leg portions which are the second left leg portion 88 of the left rear seat 22 and the second right leg portion 108 of the right rear seat 23 can be fixed (connected) to the base 18.

Here, the seat 20 includes two seats which are the left rear seat 22 and the right rear seat 23. The rear end leg section 88b of the second left leg portion 88 of the left rear seat 22 is fixed to the base 18. The rear end leg section 108b of the second right leg portion 108 of the right rear seat 23 is fixed to the base 18. Therefore, the base 18 is reinforced by the second left leg portion 88 and the second right leg portion 108.

Thereby, for example, a load F that is input due to a rear collision of the vehicle 10 can be further favorably dispersed from the base 18 to the second left leg portion 88 and the second right leg portion 108. Therefore, it is possible to further favorably prevent the stress from being concentrated on the middle portion 31a of the lower floor 31 due to the load F that is input at the time of the rear collision by the second left leg portion 88 and the second right leg portion 108.

Thereby, it is possible to further favorably prevent the lower floor 31 (the floor panel 14) from being deformed from the middle portion 31a by the second left leg portion 88 and the second right leg portion 108.

Additionally, the second left leg portion 88 of the left rear seat 22 is fixed to the base 18. The second right leg portion 108 of the right rear seat 23 is fixed to the base 18. Therefore, the left rear seat 22 and the right rear seat 23 are integrally connected by the base 18.

On the other hand, the first left leg portion 87 of the left rear seat 22 is joined to the left rear frame 12 via the left upper floor portion 33. The first right leg portion 107 of the right rear seat 23 is joined to the right rear frame 13 via the right upper floor portion 34.

Therefore, the left rear seat 22 and the right rear seat 23 are integrally connected by the base 18 and are constituted as an integral beam structure that is provided on and between the left rear frame 12 and the right rear frame 13. Thereby, for example, it is possible to further favorably prevent the stress from being concentrated on the middle portion 31a of the lower floor 31 due to the load F that is input at the time of the rear collision by the left rear seat 22 and the right rear seat 23. Accordingly, it is possible to further favorably prevent the lower floor 31 (the floor panel 14) from being deformed from the middle portion 31a by the left rear seat 22 and the right rear seat 23.

Further, by fixing the base 18 to the first cross member 15, it is possible to reinforce the base 18 and the lower floor 31 by the first cross member 15. Therefore, for example, a load F that is input due to a rear collision of the vehicle 10 can be further favorably dispersed from the base 18 to the first cross member 15.

Thereby, for example, it is possible to further favorably prevent the stress from being concentrated on the middle portion 31a of the lower floor 31 due to the load F that is input at the time of the rear collision by the first cross member 15. Accordingly, it is possible to further favorably prevent the lower floor 31 (the floor panel 14) from being deformed from the middle portion 31a by the first cross member 15.

Further, the front end leg section 88a of the second left leg portion 88 and the front end leg section 108a of the second right leg portion 108 are fixed to the front upper floor portion 35, and the rear end leg section 88b of the second left leg portion 88 and the rear end leg section 108b of the second right leg portion 108 are fixed to the base 18. Therefore, for example, a load F that is input due to a rear collision of the vehicle can be further favorably dispersed from the second left leg portion 88 and the second right leg portion 108 to the front upper floor portion 35.

That is, when the load F is input from the vehicle rearward direction due to the rear collision of the vehicle 10, the second left leg portion 88 and the second right leg portion 108 can hold on by the front upper floor portion 35 (that is, the upper floor 32). Thereby, for example, it is possible to further favorably prevent the lower floor 31 (the floor panel 14) from being deformed from the middle portion 31a due to the load F that is input at the time of the rear collision.

Additionally, the second left leg portion 88 and the second right leg portion 108 are constituted of a slide rail. Therefore, the lower end surface portion 88c of the rear end leg section 88b of the second left leg portion 88 is fixed in a state of being in surface contact with the upper surface section 53a of the upper extension portion 53, and it is possible to increase a contact area with the upper surface section 53a of the upper extension portion 53. Similarly, the lower end surface portion 108c of the rear end leg section 108b of the second right leg portion 108 is fixed in a state of being in surface contact with the upper surface section 53a of the upper extension portion 53, and it is possible to increase a contact area with the upper surface section 53a of the upper extension portion 53.

Thereby, the base 18 can be further favorably reinforced by the two slide rails of the second left leg portion 88 and the second right leg portion 108. Therefore, for example, a load F that is input due to a rear collision of the vehicle 10 can be further favorably dispersed from the base 18 to the second left leg portion 88 and the second right leg portion 108. Thereby, it is possible to further favorably prevent the lower floor 31 (the floor panel 14) from being deformed from the middle portion 31a by the two leg portions, which are the second left leg portion 88 and the second right leg portion 108.

Further, by forming the lower floor 31 in a U shape, the strength and the rigidity of the lower floor 31 itself are ensured. Thereby, for example, it is possible to further favorably prevent the lower floor 31 (the floor panel 14) from being deformed from the middle portion 31a due to a load F that is input by a rear collision of the vehicle 10.

The technical scope of the present invention is not limited to the embodiment described above, and various changes can be added without departing from the scope of the present invention.

The components in the embodiment can be appropriately replaced with well-known components without departing from the scope of the present invention, and the modification examples may be suitably combined.

What is claimed is:

1. A vehicle that comprises a floor including a lower floor on which a high-voltage electric component is arranged and an upper floor which is arranged on an upper side of the lower floor, the vehicle comprising:
a seat that is arranged above the high-voltage electric component and comprises a leg portion; and
a base that is fixed to the lower floor and is arranged on an inside in a vehicle width direction,
wherein the leg portion comprises:
a first leg portion that is arranged on an outside in the vehicle width direction of the base and is fixed to the upper floor; and
a second leg portion that is arranged on an inside in the vehicle width direction of the first leg portion and is fixed to the base.

2. The vehicle according to claim 1,
wherein the base is fixed to a cross member that is arranged along the lower floor.

3. The vehicle according to claim 1,
wherein the second leg portion includes:
a front end section at a vehicle forward side that is fixed to the upper floor; and
a rear end section at a vehicle rearward side that is fixed to the base.

4. The vehicle according to claim 1,
wherein the seat comprises a seat main body that is supported by the leg portion,
the leg portion is constituted of a pair of slide rails in which the first leg portion and the second leg portion support the seat main body slidably in a vehicle forward-rearward direction, and
the slide rail of the second leg portion is fixed to the base.

5. The vehicle according to claim 1,
wherein the seat comprises a first seat and a second seat that are individually provided in the vehicle width direction, and
the second leg portion of each of the first seat and the second seat is fixed to the base.
